(19) United States
(12) Patent Application Publication
(10) Pub. No.: US 2024/0348133 A1
(43) Pub. Date: Oct. 17, 2024

(54) METHOD AND TOOL FOR ASSEMBLING AN ELECTRIC MACHINE ROTOR

(71) Applicants: AMPERE S.A.S., Boulogne Billancourt (FR); WHYLOT, Cambes (FR)

(72) Inventors: Romain FLEURISSON, Figeac (FR); Nicolas MARCHAL, Saint Cyr l'Ecole (FR); Frederic MAUDET, YERRES (FR); Loic MAYEUR, St Santin (FR); Maxime TOLU, GREZES (FR)

(21) Appl. No.: 18/294,737

(22) PCT Filed: Jul. 27, 2022
(86) PCT No.: PCT/EP2022/071019

§ 371 Date: Feb. 2, 2024

(30) Foreign Application Priority Data
Aug. 4, 2021 (FR) 2108464

(51) Int. Cl. H02K 15/03; H02K 1/2796; H02K 21/24

(52) U.S. Cl. CPC H02K 15/03; H02K 1/2796; H02K 21/24

(57) ABSTRACT

This relates to a tool and a method for assembling an electric machine rotor, including a rotor body and magnetic pole elements. The process includes: placing a lower seal on a bearing element; positioning the rotor body and the magnetic pole elements on a support in such a way that they define between them spaces closed on the support side by the lower seal; placing an upper seal on the rotor body and the magnetic pole elements so that it closes the spaces on the side opposite to the support; and injecting a joining material into the spaces, through holes made in at least one of the lower seal and upper seal.

### TECHNICAL FIELD OF THE INVENTION

The present invention relates in general to the field of electric machines.

It relates more particularly to a method for assembling an electric machine rotor including a rotor body and magnetic pole elements (typically magnets).

It also relates to a tool for assembling such a rotor, as well as a rotor obtained via this assembly method.

The invention has a particularly advantageous use in the manufacturing of rotors for axial flux electric machines.

### PRIOR ART

An electric or hybrid motor vehicle includes a power train that comprises an electric machine.

The electric machine includes a rotor that is mounted on an output shaft, which is connected to the drive wheels of the vehicle.

For example, the electric machine can be of the axial flux type and include a case in two parts, which houses a rotor in the form of a disc flanked by two stators. The stators are thus slightly moved apart on either side of the rotor to avoid any friction when the rotor rotates. Thus, on each side of the rotor there is a space called “air gap”.

The performance of the electric machine depends on the value of these air gaps (it must be minimal), on their constancy all around the axis of rotation of the rotor, and on the symmetry of these air gaps on either side of the rotor. The slightest error in geometry has consequences on the performance of the motor and on its service life. For example, it is understood that a difference in values between the two air gaps causes an attraction of the rotor by the closest stator. This stress can be significant. It can furthermore be cyclic and cause fatigue in the materials forming the electric machine.

These problems are inherent to the concept of an axial flux electric machine itself.

In this context, it is understood that it should be ensured that the components of the rotor are well fastened to each other and assembled with precision.

The major problem that is posed thus relates to the fastening of the magnets to the rotor body.

One possible method involves providing a rotor body in the shape of a star, the branches of which define between them housings for receiving the magnets. An annular binding band is thus placed around the magnets and the rotor body, so as to block the magnets against the rotor body. A polymerizable resin is then introduced between the magnets and the rotor body so as to block the various components of the rotor relative to each other.

The difficulty involves spreading the resin well between the magnets and the rotor body so as to ensure good relative positioning of the magnets, while avoiding this resin forming beads on each face of the rotor, which would otherwise risk rubbing against the stators. At present, no known method allows to fully reach this goal.

### PRESENTATION OF THE INVENTION

Thus, according to the invention, a method for assembling an electric machine rotor is proposed, which includes steps of:
positioning the rotor body and the magnetic pole elements on a support in such a way that they define between them spaces closed on the support side by a lower seal,
placing an upper seal on the rotor body and the magnetic pole elements so that it closes the spaces on the side opposite to the support,
injecting a joining material into the spaces, through holes made in at least one of the lower seal and upper seal.

The invention also relates to a rotor assembled via such a method.

According to the invention, a tool for assembling an electric machine rotor is also proposed that includes:
a support capable of receiving the rotor body and the magnetic pole elements in such a way that they define between them spaces closed on the support side by a lower seal,
a press element adapted to block an upper seal on the rotor body and on the magnetic pole elements, so that it closes the spaces on the side opposite to the support, and
means for injecting a joining material into said spaces, through holes made in at least one out of the lower seal and upper seal.

Thus, via the invention, it is possible to inject a polymerizable resin (or any other suitable joining material) between the magnetic pole elements and the rotor body, while maintaining these various elements with respect to each other, which allows to ensure a geometrically perfect assembly of the rotor. As for the presence of the seals, it allows to guarantee the absence of a bead on one and the other of the two faces of the rotor.

Thus, the rotor obtained has the solidity required and the desired shape, which guarantees that the vibrations generated by the electric machine when the rotor rotates at very high speed remain reduced.

Other advantageous and non-limiting features of the assembly method according to the invention, taken alone or according to all the technically possible combinations, are the following:
the lower seal is positioned on a bearing element;
elastically deformable means are interposed between the bearing element and the support;
after the step of positioning the rotor body and the magnetic pole elements on the support, there is a step of blocking in position the rotor body and the magnetic pole elements by a clamping stop sandwiching the rotor body and the magnetic pole elements with the support;
the rotor comprising a binding band located on the contour of the magnetic pole elements, during the positioning step, the binding band is positioned on the support, and after the placing step, the upper seal and the lower seal close spaces located between the binding band and the magnetic pole elements, on the support side and on the side opposite to the support;
after the step of positioning the rotor body and the magnetic pole elements on the support, there is a step of compressing the lower and upper seals against the rotor by a press element adapted to bear against the upper seal.

Other advantageous and non-limiting features of the assembly tool according to the invention, taken alone or according to all the technically possible combinations, are the following:
elastically deformable means interposed between the bearing element and the support are provided;
the press element has a distribution duct into which the injection means open and which allows to spread the joining material towards each of said holes;
said distribution duct has a circular shape and the press element has injection shafts that open, on one side, into said distribution duct, and on the other towards said holes.

Of course, the various features, alternatives and embodiments of the invention can be associated with each other according to various combinations insofar as they are not incompatible or exclusive of each other.

### DETAILED DESCRIPTION OF THE INVENTION

The following description with regard to the appended drawings, given as non-limiting examples, will make it clear what the invention consists of and how it can be carried out.

In the appended drawings:

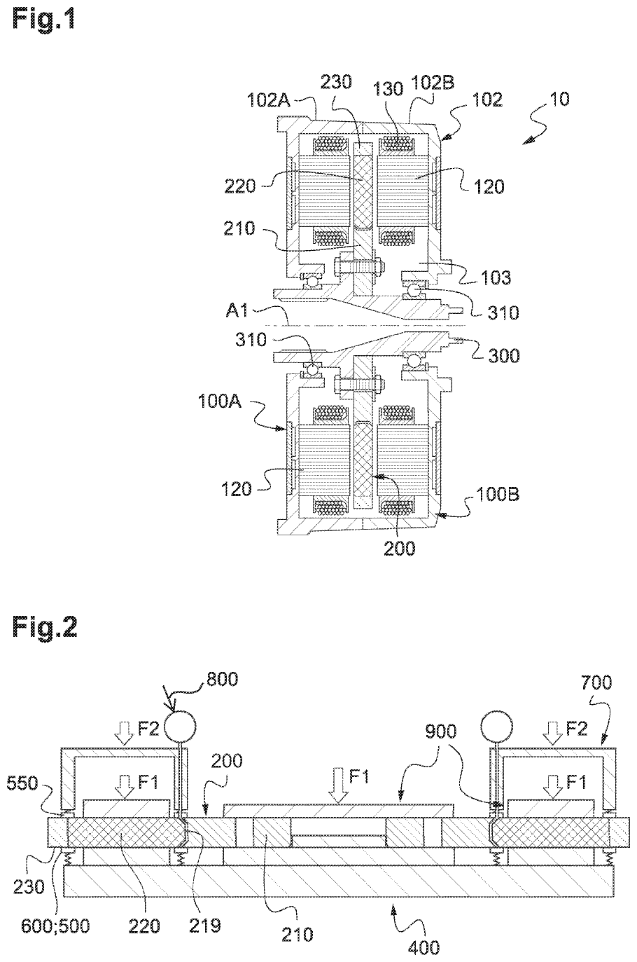

FIG. 1 is a cross-sectional diagram of an electric machine comprising a rotor according to the invention;

FIG. 2 is an illustration of the principle of assembly of the rotor of FIG. 1, according to a method according to the invention;

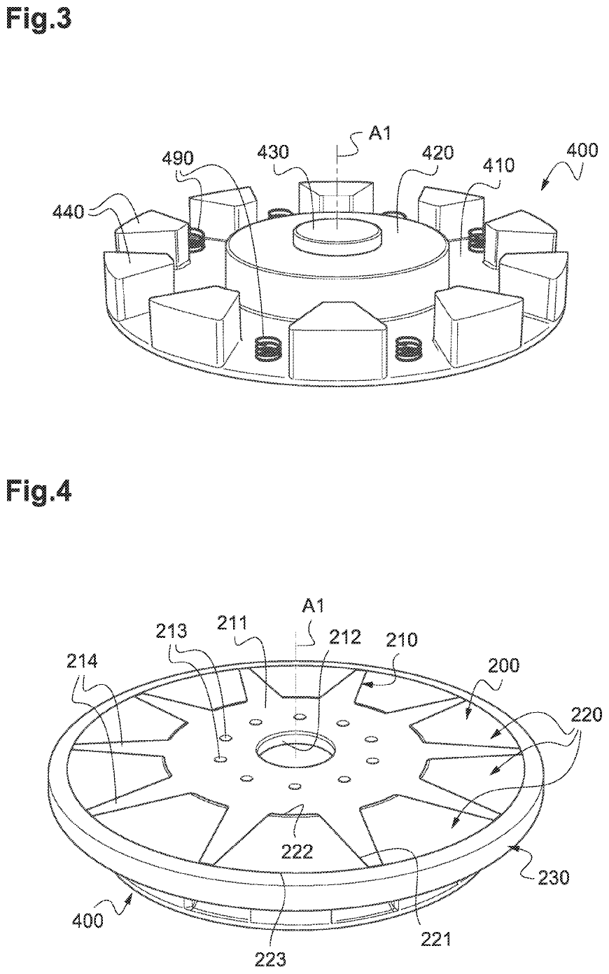

FIG. 3 is a perspective diagram of a support of a tool for assembling the rotor of FIG. 1;

FIG. 4 is a schematic perspective top view of the rotor of FIG. 1 placed on the support of FIG. 3;

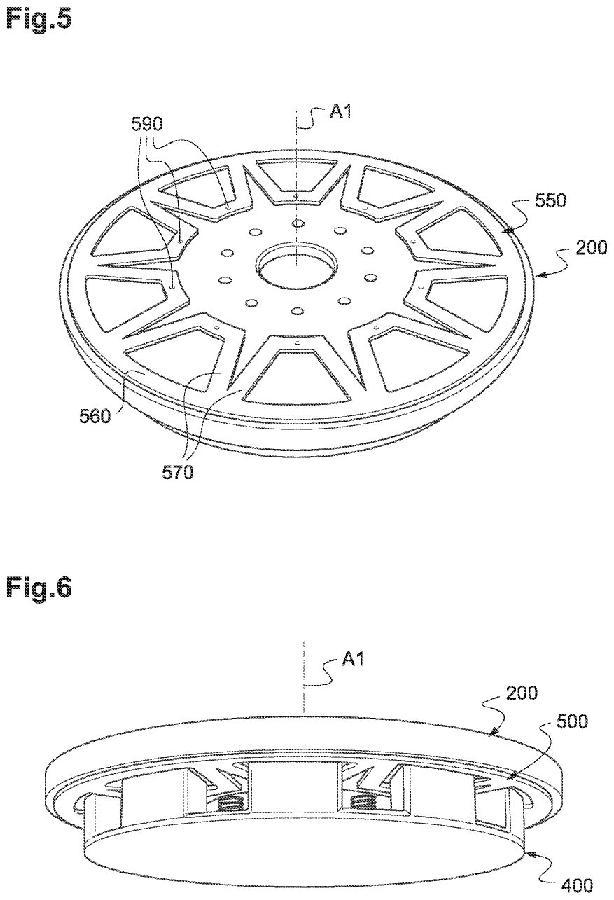

FIG. 5 is a view homologous to that of FIG. 4, representing an upper seal placed on the rotor of FIG. 1;

FIG. 6 is a schematic perspective bottom view of the rotor of FIG. 1 placed on the support of FIG. 3, in which a lower seal appears;

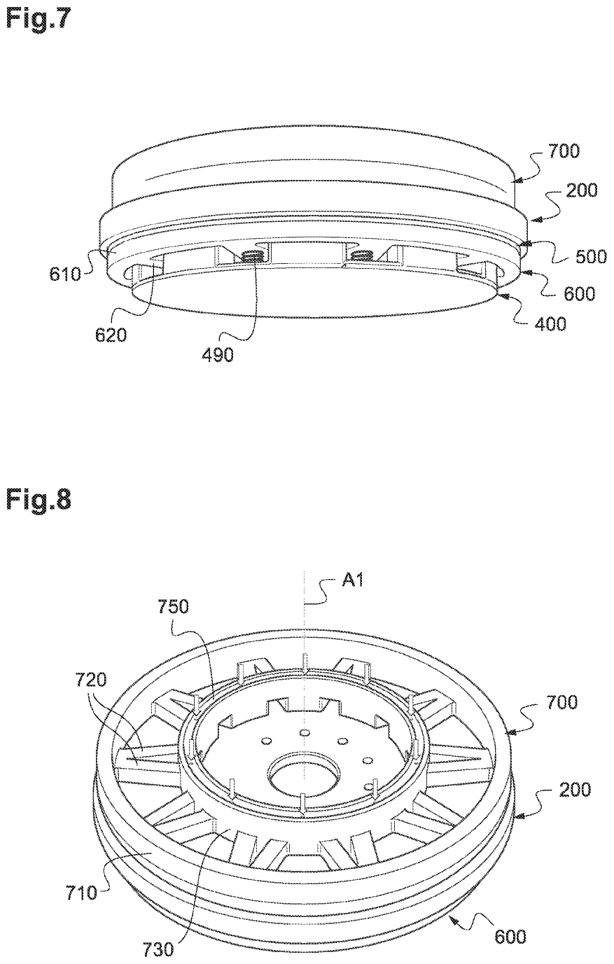

FIG. 7 is a view homologous to that of FIG. 6, in which a bearing element and a press element of the assembly tool of FIG. 3 are also shown;

FIG. 8 is a schematic perspective top view of the assembly tool of FIG. 3;

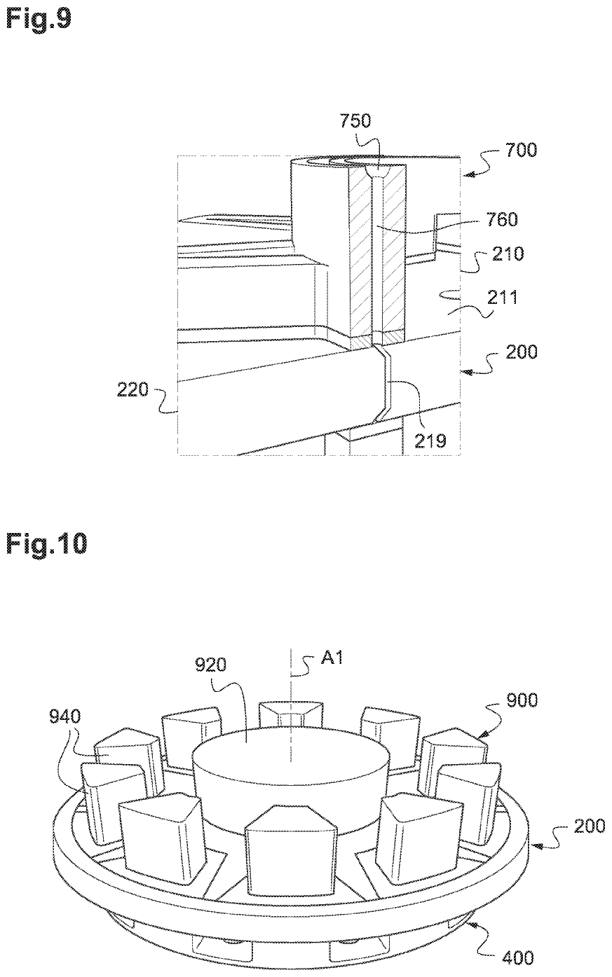

FIG. 9 is a cross-sectional view of an injection shaft of the press element of FIG. 7;

FIG. 10 is a schematic perspective top view of the rotor of FIG. 1, on which a clamping stop of the assembly tool of FIG. 3 is placed.

### INTRODUCTION

FIG. 1 shows an electric machine of a power train that can in particular be installed in an electric or hybrid propulsion motor vehicle.

The electric machine 10 is of the axial flux type. It includes at least one rotor 200 and at least one stator. Here, it includes a single rotor 200 flanked by two stators 100A, 100B.

This electric machine 10 includes a hollow case 102 in two parts 102A, 102B screwed one onto the other, which define a housing 103 inside of which the rotor 200 is located.

The rotor 200 has overall the shape of a not very thick disc, pierced in its center. It includes a rotor body 210 and a peripheral binding band 230 which maintain relative to each other magnetic pole elements (here magnets 220 that are one-piece or formed by a plurality of unit magnets) regularly distributed around an axis of rotation A1. The rotor body 210 and the binding band 230 are made from non-magnetic materials, for example from a composite material.

The rotor body 210 is screwed onto an output shaft 300 which extends axially according to the axis of rotation A1 and which is connected to the drive wheels of the motor vehicle.

The binding band 230 allows, when the rotor rotates, to absorb the centrifugation stresses of the magnets 220 in order to preserve the cohesion of the rotor 200 at high speed.

The stators 100A, 100B are placed on either side of the rotor 200 and they are designed so that the electric machine 10 has the smallest bulk possible. They are connected to the output shaft via bearings 310.

They each include teeth 120 that are fastened onto one of the parts of the case 102 so as to be regularly distributed around the axis of rotation A1, and coils 130 of electric wires mounted on the teeth 120 and connected to an electric power supply so as to be able to rotate the rotor 200.

### Rotor

The invention relates more precisely to the rotor 200, which can thus be described in more detail.

As shown in FIG. 4, the rotor body 210 is flat and has a constant thickness, substantially equal to that of the magnets 220 and of the binding band 230 (according to the axis of rotation A1).

It has a “star” or “sun” shape, with in particular a central hub 211 and spokes 214.

The central hub 211 has the shape of a disc pierced in its center by a circular opening 212 for the passage of the output shaft 300.

Through-holes 213 are distributed in this central hub 211 around the circular opening 212, to allow the screwing of the rotor 200 onto a flange of this output shaft 300.

The spokes 214 extend radially from the outer edge of the central hub 211, towards the outside. These spokes 214 extend here in a rectilinear manner and have decreasing widths from the central hub 211 towards the outside.

These spokes 214 define between them, and with the central hub 211, spaces for receiving the magnets 220.

As well shown by this same FIG. 4, the magnets 220 all have identical shapes, complementary to those of the aforementioned receiving spaces.

They thus have flat shapes and constant thicknesses. Each magnet thus includes two flat faces respectively facing towards the two stators 100A, 100B, and a thickness side that has two rectilinear lateral edges 221 bearing against the spokes 214, an inner edge 222 in the shape of a concave arc of a circle bearing against the central hub 211 of the rotor body 210, and an outer edge 223 in the shape of a convex arc of a circle bearing against the binding band 230.

As for this binding band 230, it has an annular shape with a square cross-section. It is intended for it to clasp the magnets 220 and to bear against the free ends of the spokes 214 of the rotor body 210.

Here, the outer edge 223 of each magnet 220 (the one bearing against the binding band 230) is straight in the sense that its cross-section in a plane comprising the axis of rotation A1 forms a segment. Of course, alternatively, it could have a different shape so as to ensure better maintaining of the binding band 230.

It is possible for the other edges 221, 222 of the magnets 220 to also be straight.

However, preferably, as shown in the axial cross-sectional view shown in FIG. 9, at least one of the other edges of each magnet 220 has an axial cross-section (in a plane parallel to the axis of rotation A1) that is not straight. Here, the lateral 221 and inner 222 edges of the magnets 220 are not straight so as to be able to fit into the rotor body 210 (which ensures a maintaining of the magnets according to the axis of rotation A1).

In this FIG. 9, an axial cross-section of the inner edge 221 of one of the magnets 220 has thus been shown. It is noted that the upper and lower edges of the inner edge 221 of the magnet 220 are beveled and that the corresponding edge of the rotor body 210 is hollowed out to have a complementary shape (with a straight bottom and two upper and lower ribs inclined by 45 degrees).

Of course, alternatively, the magnets could have sides having different shapes.

As FIG. 9 shows well, there is still a clearance between the magnet 220 and the central hub 211 of the rotor body 210. Such a clearance also appears between the magnet 220 and the spokes 214 of the rotor body 210, or even also between the magnet 220 and the binding band 230. Thus, once the binding band 230 and the magnets 220 have been assembled on the rotor body 210, a space 219 appears between the magnet 220 and the rotor body 210.

If this space were to be considered, locally or over the entire contour of the magnet 200, too small, it would be possible to make a shallow groove in the rotor body 210 and/or in the binding band 230 to allow a larger quantity of resin to penetrate around each magnet 220.

It is thus intended to inject a joining material into each space 219 in order to block the magnets 220 in a rigid manner. This material is chosen in order to ensure an effective and durable blocking, despite the stresses (in particular vibrational) to which the rotor will be subjected.

The joining material could be a glue or a varnish. Preferably, here it is a hardenable polymer, typically a resin made of thermosetting polymer.

### Tool

At this stage, it will be possible to describe the tool allowing to assemble the rotor 200 without difficulty, in an industrializable manner.

This tool is provided to allow to block the magnets 220 and the rotor body 210 in position during the injection of resin into the spaces 219.

It is shown schematically in FIG. 2. It is observed therein that it includes several distinct parts, namely:
a support 400 (shown in more detail in FIG. 3) adapted to receive the rotor 200,
a lower seal 500 placed under the rotor 200 to close the aforementioned spaces 219, from below,
an upper seal 550 placed on the rotor 200 in order to also close the spaces 219, from above,
a bearing element 600 (shown in more detail in FIG. 7) mounted on the support 400 to block the lower seal 500 under the rotor 200,
a press element 700 (shown in more detail in FIG. 7) placed above the rotor 200, to compress the upper seal on the rotor 200,
a clamping stop 900 (shown in more detail in FIG. 10) adapted to sandwich the rotor 200 with the support 400, and
means 800 for injecting the resin.

In this FIG. 2, the arrows F1 illustrate well the clamping of the rotor 200 between the clamping stop 900 and the support 400, at both the rotor body 210 and the magnets 220. Only the binding band 230 is not sandwiched between these two elements, since it is already solidly fastened around the magnets 220.

As for the arrows F2, they illustrate the compressive force applied by the press element 700 onto the upper seal 550.

FIG. 3 shows in more detail the support 400. It is observed therein that it includes a bottom plate 410 that is circular here, having a diameter slightly smaller than that of the rotor 200. Alternatively, this bottom plate could have very different shapes.

The support 400 includes, protruding from the center of the upper face of this bottom plate 410, a cylindrical pad 420 that carries at its top a cylindrical pin 430 having a smaller diameter.

The flat top of the cylindrical pad 420 is provided to form a support for the lower face of the central hub 211 of the rotor body 210.

As for the cylindrical pin 430, it is provided to be inserted into the central opening 212 of the central hub 211 of the rotor body 210.

Thus, these cylindrical pad and pin 420, 430 are provided to receive the rotor body 210 while maintaining it in a fixed and known position.

It is noted that it is possible to provide, protruding from the flat top of the cylindrical pad 420, an off-center pin adapted to be inserted into one of the through-holes 213 of the central hub 211 of the rotor body 210, in order to block this central hub 211 with a well-defined orientation with respect to the support 400.

Moreover, this support 400 includes peripheral pads 440 that are located around the cylindrical pad 420, at a distance from the latter, and which have here prismatic shapes with a flat top designed to each receive one of the magnets 220 of the rotor 200. The height of these peripheral pads 440 is identical to that of the cylindrical pad 420, so as to ensure that the magnets 220 are placed at the same height as the rotor body 210. The number of peripheral pads 440 is identical to the number of magnets 220. These peripheral pads 440 have widths smaller than those of the magnets, so as to not interfere with the binding band 230 or with the rotor body 210 or with the lower seal 500.

These peripheral pads 440 are regularly distributed around the central axis of the support 400 (shared with the axis of rotation A1) and they define between them free spaces in which the lower seal 500 and the bearing element 600 (for which it is recalled that it carries the lower seal 500) can be placed.

To retain the bearing element 600 at a distance from the support 400, elastically deformable means are interposed between the bearing element 600 and the support 400 (see FIG. 7).

Here, as shown by FIG. 3, these elastically deformable means are in the form of compression springs 490. At least three distinct springs 490 are provided. In practice, to ensure a good distribution of the stresses under the bearing element 600, a spring 490 is provided in each free space defined between the peripheral pads 440 of the support 400.

FIG. 7 shows the bearing element 600. It is observed therein that it includes a peripheral crown 610 and spokes 620 that extend between this peripheral crown 610 and an inner crown (not visible). This bearing element 600 has a flat lower face, which bears on the springs 490, and a flat upper face on which the lower seal 500 bears.

Its shape allows it to be placed under the entirety of the lower face of the lower seal 500.

FIG. 6 shows the support 400, the rotor 200 and the lower seal 500, but the bearing element 600 has not been shown in order to see the lower seal 500.

This lower seal 500 is identical to the upper seal 550, with the exception that it is not pierced by holes.

It is thus possible to only describe the upper seal 550 below.

As shown by FIG. 5, the upper seal 550 is flat. It has a reduced thickness and is made from a compressible material, namely at least two times more compressible (under identical stress) than the other elements of the tool. It is made here from an elastomer.

This upper seal 550 has several angular sectors having identical shapes, which are repeated around the axis of rotation A1.

It thus includes a circular outer crown 560, starting from the inner face from which a plurality of U-shaped elements (hereinafter called handles 570) extend.

Each handle 570 includes two straight arms, the free ends of which are attached to the outer crown 560, and a base in the shape of an arc of a circle centered on the axis of rotation A1.

The outer crown 560 and the handles 570 are formed by strips of seal having a rectangular cross-section and a width much greater than that of the spaces 219.

The upper seal 550 is thus provided to be placed above each of the spaces 219 and on either side thereof, so as to hermetically close this space on one side of the rotor 200.

Unlike the lower seal 500, the upper seal 550 is pierced with through-holes 590. There are as many through-holes 590 in the upper seal 550 as magnets 220 in the rotor 200. These through-holes 590 are regularly distributed around the axis of rotation A1.

As will be clear below, these through-holes 590 are provided to allow the injection of resin into the spaces 219.

FIG. 8 shows more particularly the press element 700, for which it is recalled that it allows to compress the upper seal 550 against the rotor 200.

This press element 700 has an overall shape rather close to that of the bearing element 600.

It thus includes a peripheral crown 710, an inner crown 730, and spokes 720 that extend between these two crowns.

It has a flat lower face that bears on the upper seal 550.

Its shape allows it to be placed above the entirety of the upper face of the upper seal 550.

In practice, for reasons of bulk, it has a lower face having a shape substantially identical to that of the upper seal 550.

Thus, the peripheral crown 710 has a flat lower face having a shape identical to that of the upper face of the outer crown 560 of the upper seal 550. The spokes 720 have flat lower faces having shapes identical to those of the upper faces of the arms of the U of the handles 570 of the upper seal 550. The inner crown 730 has a flat lower face having a shape such that it covers the bottoms of the U of the handles 570 of the upper seal 550.

FIG. 10 shows the clamping stop 900, for which it is recalled that it allows to sandwich each of the magnets 220 and the rotor body 210 with the support 400, by being interposed between the spokes 720 of the press element 700.

It is observed therein that it includes a central cylindrical pad 920 having a shape identical to that of the central cylindrical pad 420 of the support 400, and peripheral pads 940 having shapes identical to those of the peripheral pads 440 of the support 400.

This shape allows the support 400 and the clamping stop 900 to not interfere with the bearing element 600 and the press element 700.

FIG. 2 schematically shows the means 800 for injecting resin.

In practice, these injection means 800 include a tank for storing resin and a pump adapted to take resin stored in the tank to inject it under pressure into a connected pipe towards the spaces 219.

To transport this resin from the pipe into the spaces 219, the press element 700 has a distribution duct 750 (see FIG. 8) into which this pipe opens and which allows to distribute the joining material towards injection shafts 760 (FIG. 9) that open into the through-holes 590 provided in the upper seal 550.

Here, as shown in FIG. 8, the distribution duct 750 is formed by an annular channel that extends in the inner crown 730 of the press element 700, all around the axis of rotation A1.

As shown in FIG. 9, the injection shafts 760 start in this distribution duct 750 and extend parallel to the axis of rotation A1, throughout the thickness of the inner crown 730, so as to open into the through-holes 590.

It is noted here that to ensure a perfect centering of the upper seal 550 with respect to the press element 700, these two components can be fastened to one another, for example by gluing.

Likewise, the lower seal 500 can be fastened to the bearing element 600.

Moreover, it is noted that the various components of the tool (except for the seals) must be sufficiently rigid to ensure an effective blocking of the rotor and a homogeneous compression of the joints. For this reason, they are preferably made from rigid metal materials (typically of steel).

### Method

At this stage, the method for assembling the rotor 200 can be described.

First of all, the tool is prepared so that the bearing element 600 is positioned above the springs 490 placed on the support 400, and so that it is covered by the lower seal 500.

Then the rotor 200 is installed on the lower seal 500. It is preferably installed by a robotized arm ensuring a perfect centering of the elements of the rotor with respect to each other. As for the shape of the support 400, it guarantees a perfect centering of the rotor with respect to the tool and a perfect levelling of the elements of the rotor 200.

The rotor 200 can be installed in the pre-assembled state, or part by part.

Here, it is considered that it is installed in the pre-assembled state, that is to say that the magnets 220 will already have been fitted into the rotor body 210 and that the binding band 230 will have been shrunk around the magnets 220 and the ends of the spokes 214 of the rotor body 210. It is noted that in this configuration, the shape of the various components of the rotor 200 is such that a space 219 extends around each magnet 220.

At this stage, the press element 700 (covered by the upper seal 550) and the clamping stop 900 are added on top of the rotor 200.

They allow to guarantee the sealing on the top of the spaces (that below is guaranteed by the lower seal) and the immobilization of the magnets 220 with respect to the rotor body 210.

Finally, the pump of the injection means 800 is activated so as to inject the pressurized resin into the spaces 219 located around the magnets 220.

It is noted here that while the binding band, the magnets and the rotor body have here substantially identical thicknesses, it is possible for this thickness to vary slightly, because of dispersions in their manufacturing chain. The thickness of the seals and the material used to create these seals are thus provided in such a way that these seals can be compressed and deformed so as to ensure the desired sealing above and below each space 219.

The rotor 200 thus immobilized is then placed in a furnace to allow the polymerization of the resin.

Once cooled, the rotor can be taken out of the tool and installed between the two stators of the electric machine 10.

### Alternatives

The present invention is in no way limited to the embodiment described and shown, but a person skilled in the art will be able to provide any alternative thereto according to the invention.

For example, the bearing element 600 and the support 400 can form a single one-piece part. In this alternative, the lower seal must thus be dimensioned in thickness so as to be able to be compressed more than in the embodiment shown in the drawings, so as to be able to compensate for the manufacturing defects of the elements of the rotor.

According to another alternative of the invention, each seal can be made of several distinct parts (for example of several angular sectors).

Each seal could also have not a single layer, but several superimposed layers.

Likewise, the support, the bearing element, the press element and the clamping stop could be made of several distinct parts.

1. Method for assembling an electric machine rotor, including a rotor body and magnetic pole elements, said method including steps of:
positioning the rotor body and the magnetic pole elements on a support in such a way that they define between them spaces closed on the support side by a lower seal,
placing an upper seal on the rotor body and the magnetic pole elements so that it closes the spaces on the side opposite to the support,
injecting a joining material into the spaces, through holes made in at least one of the lower seal and upper seal.

2. The assembly method according to claim 1, wherein the lower seal is positioned on a bearing element and wherein elastically deformable means are interposed between the bearing element and the support.

3. The assembly method according to claim 1, wherein, after the step of positioning the rotor body and the magnetic pole elements on the support, there is a step of blocking in position the rotor body and the magnetic pole elements by a clamping stop sandwiching the rotor body and the magnetic pole elements with the support.

4. The assembly method according to claim 1, wherein the rotor comprising a binding band located on the contour of the magnetic pole elements, during the positioning step, the binding band is positioned on the support, and after the placing step, the upper seal and the lower seal close spaces located between the binding band and the magnetic pole elements, on the support side and on the side opposite to the support.

5. The assembly method according to claim 1, wherein after the step of positioning the rotor body and the magnetic pole elements on the support, there is a step of compressing the lower and upper seals against the rotor by a press element adapted to bear against the upper seal.

6. Electric machine rotor including a rotor body and magnetic pole elements assembled via an assembly method according to claim 1.

7. Tool for assembling an electric machine rotor including a rotor body and magnetic pole elements, said tool including:
a bearing element adapted to receive a lower seal,
a support adapted to receive the rotor body and the magnetic pole elements in such a way that they define between them spaces closed on the support side by the lower seal,
a press element adapted to block an upper seal on the rotor body and on the magnetic pole elements, so that it closes the spaces on the side opposite to the support, and
means for injecting a joining material into said spaces, through holes made in at least one of the lower seal and upper seal.

8. The assembly tool according to claim 7, further comprising elastically deformable means interposed between the bearing element and the support.

9. The assembly tool according to claim 7, further comprising a clamping stop adapted to sandwich the rotor body and the magnetic pole elements with the support.

10. The assembly tool according to claim 7, wherein the press element has a distribution duct into which the injection means open and which allows to spread the joining material towards each of said holes.

11. The assembly tool according to claim 10, wherein said distribution duct has a circular shape and the press element has injection shafts which open, on one side, into said distribution duct, and on the other towards said holes.
